(19) United States
(12) Patent Application Publication
(10) Pub. No.: US 2004/0032687 A1
(43) Pub. Date: Feb. 19, 2004

(54) Head-slap detection for a data storage device

(76) Inventors: Hwa Liang Ng, Singapore (SG); Chong Ngiap Pang, Singapore (SG); George P. Thomas, Singapore (SG); Ching Lam Seah, Singapore (SG)

Correspondence Address: Mitchell McCarthy, Seagate Technology LLC, Intellectual Property - OKM270, 10321 West Reno, Oklahoma City, OK, 73127-7140, US

(21) Appl. No.: 10/455,581

(22) Filed: Jun. 5, 2003

Related U.S. Application Data
(60) Provisional application No. 60/403,022, filed on Aug. 13, 2002.

(51) Int. Cl. G11B 21/02; G11B 27/36

(52) U.S. Cl. 360/75; 360/31

(57) ABSTRACT

A data storage device and head-slap detection circuit combination for determining whether a data storage device encounters a head-slap event. The data storage device includes a data transducing head with a conductive film affixed thereon adjacent a conductive surface attached to a recording surface. A continuity circuit is formed by connecting the head-slap detection circuit to the conductive surface with a first lead and to the conductive film with a second lead. The head-slap detection circuit compares a resistance between the conductive surface and the conductive film to a threshold resistance level and reports a duration of a head-slap event upon a change in resistance between the conductive surface and the conductive film exceeding the threshold resistance level. A level of impact force experienced by the combination is translated from an empirically determined head-slap boundary curve based on the duration of the head-slap event.

### RELATED APPLICATIONS

This application claims priority to U.S. Provisional Application No. 60/403,022 filed Aug. 13, 2002 entitled “HEAD-SLAP DETECTION USING HEAD/DISC CONTINUITY MONITORING TECHNIQUE.”

### FIELD OF THE INVENTION

The claimed invention relates generally to the field of digital data storage systems, and more particularly but not by way of limitation, to detection of a head-slap occurrence in a data storage device.

### BACKGROUND

Disc drives are used for data storage in modern electronic products ranging from digital cameras to network systems. A disc drive includes a mechanical portion, or head disc assembly, and electronics in the form of a printed circuit board assembly mounted to the head disc assembly. The printed circuit board assembly controls functions of the head disc assembly while providing a communication interface between the disc drive and its host.

The head disc assembly has a disc rotated at a constant speed by a spindle motor assembly and a position controllable actuator assembly, which supports a read/write head that selectively writes data to and reads data from the disc.

The disc drive market continues to place pressure on the industry for disc drives with improved reliability. Handling shock imparted to disc drives during assembly, testing and shipping may result in the disc drive experiencing a head-slap event. A head-slap event occurs when an externally induced mechanical shock imparts sufficient energy to cause the heads to separate from the discs and abruptly return to the discs, i.e., “slap” back onto the discs. Head-slap events cause damage to both the disc and the head, creating quality and reliability issues.

As such, challenges remain and a need persists for improvements in detection of head-slap events.

### SUMMARY OF THE INVENTION

In accordance with preferred embodiments, a combination of a disc drive and head-slap detection circuit is provided for determining a head-slap event for a data storage device. The disc drive includes a data transducing head with a conductive film affixed thereon adjacent a conductive surface attached to a recording surface. A continuity circuit is formed by connecting the head-slap detection circuit to the conductive surface with a first lead and to the conductive film with a second lead.

The head-slap detection circuit includes a comparator, which compares a resistance between the conductive surface and the conductive film (provided by a resistance detection circuit of the head-slap detection circuit) to a threshold resistance level (provided by a resistance threshold register of the head-slap detection circuit). A difference between the conductive surface and the conductive film interface resistance and the threshold resistance level results in a latch circuit (of the head-slap detection circuit) latching a constant frequency signal provided by a clock circuit (of the head-slap detection circuit) to a counter of the head-slap detection circuit.

The counter measures duration of the difference between the conductive surface and the conductive film interface resistance and the threshold resistance level, and provides an indicator (of the head-slap detection circuit) with the measured duration. The measured duration is translated into an impact force experienced by the combination through the use of an empirically determined head-slap boundary curve.

These and various other features and advantages that characterize the claimed invention will be apparent upon reading the following detailed description and upon review of the associated drawings.

### BRIEF DESCRIPTION OF THE DRAWINGS

FIG. 1 is a plan view of a head-slap detection circuit, adapted to a disc drive to form a combination, the combination constructed and operated in accordance with preferred embodiments of the present invention.

FIG. 2 is a functional block diagram of the head-slap detection circuit of FIG. 1.

FIG. 3 is an elevational partial cross-sectional view of the disc and the head in steady state contact with the conductive surface of the combination of FIG. 1.

FIG. 4 is an elevational partial cross-sectional view of the disc and the head in a first stage separation from the conductive surface of the combination of FIG. 1.

FIG. 5 is an elevational partial cross-sectional view of the disc and the head in a second stage separation from the conductive surface of the combination of FIG. 1.

FIG. 6 is an elevational partial cross-sectional view of the disc and the head in an impact position with the conductive surface of the combination of FIG. 1.

FIG. 7 is a graphical representation of a head-slap shock boundary curve for the combination of FIG. 1.

FIG. 8 is a flowchart of a method of detecting a head-slap event for the disc drive of the combination of FIG. 1.

FIG. 9 is a flowchart of a method of determining a level of impact force experienced by the disc drive of the combination of FIG. 1 based on detecting the head-slap of FIG. 8.

### DETAILED DESCRIPTION

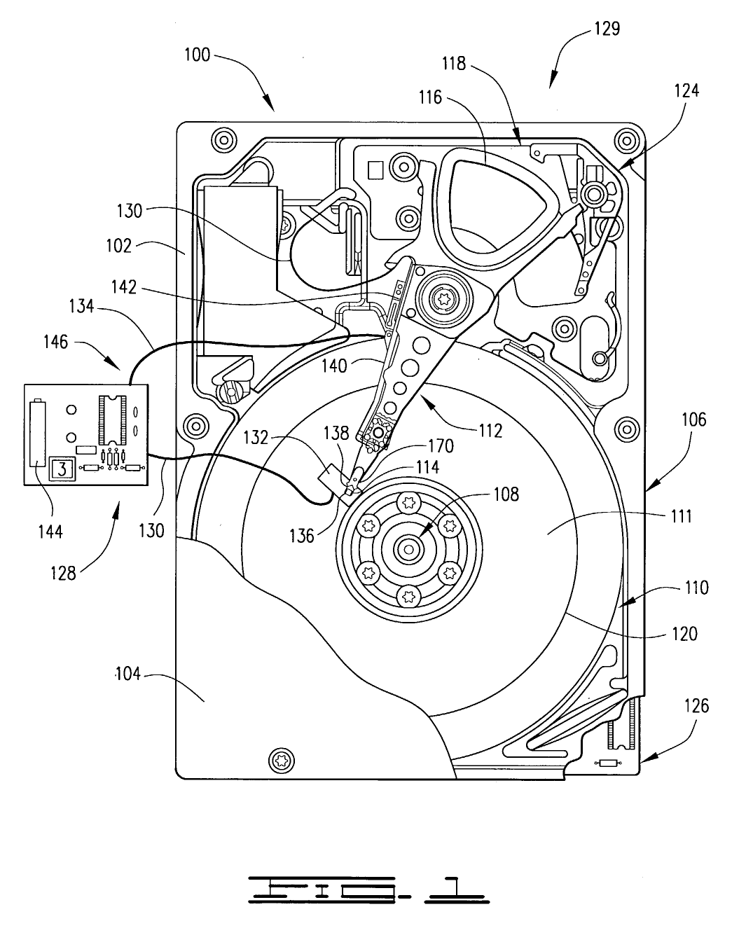

Referring now to the drawings, FIG. 1 provides a top plan view of a disc drive 100. The disc drive 100 includes a rigid base deck 102, which cooperates with a top cover 104 (shown in partial cutaway) to form a sealed housing for the device. A spindle motor 106 with a spindle motor hub 108 rotates a number of magnetic data storage discs 110 at a constant high speed, each magnetic data storage disc 110 including a recording surface 111. A rotary actuator 112 supports a number of data transducing heads 114 (also referred to herein as read/write heads 114 or heads 114) adjacent the recording surface 111. The actuator 112 is rotated through application of a current to a coil 116 of a voice coil motor (VCM) 118.

During data transfer operations with a host device (not shown), the actuator 112 moves the heads 114 to data tracks (one represented at 120) on the recording surface 111 to write data to and read data from the discs 110. When the disc drive 100 is deactivated, the actuator 112 removes the heads 114 from the tracks 120; the actuator 112 is then confined by latching a toggle latch 124. Command and control electronics for the disc drive 100 are provided on a printed circuit board assembly (PCB) 126 mounted to the underside of the base deck 102.

In a preferred embodiment, a head-slap detection circuit 128 is adapted to the disc drive 100 to form a disc drive and head-slap detection circuit combination 129. The head-slap detection circuit 128 communicates through a first lead 130 with a conductive surface 132 attached to the recording surface 111, and through a second lead 134 with a conductive film 136 affixed to the head 114.

In a preferred embodiment, the conductive film 136 is provided by sputtering a gold film on the surface of the head 114. The conductive film 136 overcoats a solder joint 138 that secures a head lead 140 to the head 114. The head lead 140 conducts signals between a preamp 142 and the head 114 during data transfer operations. During mechanical shock testing, the head lead 140 provides a conductive path between the conductive film 136 and the second lead 134. The second lead 134 provides a conductive path between the head lead 140 and the head-slap detection circuit 128.

In a preferred embodiment, the conductive surface 132 is a conductive label pad with a conductive side and an adhesive side. The adhesive side provides a means for attaching the conductive surface 132 to the disc 110, while electrically insulating the conductive side of the conductive surface 132 from the disc 110. A power source, such as a battery 144, powers the electronics of the head-slap detection circuit 128. The power source 144 also provides current to the conductive film 136 on the head 114 and to the conductive surface 132 to form a continuity circuit 146 of the head-slap detection circuit 128.

In a preferred embodiment, a resistance of the continuity circuit 146 is set to less than 1 K ohms. While monitoring for an occurrence of a head-slap event, the resistance of the continuity circuit 146 is compared to a threshold resistance value. The threshold resistance value is set to substantially the resistance value of the resistance of the continuity circuit 146.

A rise in the resistance present in the continuity circuit is a result of a separation of the conductive film 136 from the conductive surface 132. The separation between the conductive film 136 and the conductive surface 132 is an outcome of the disc drive 100 encountering a mechanical shock. The duration of the rise in resistance is proportional to the amount of force imparted on the disc drive 100 by the mechanical shock.

Turning to FIG. 2, shown therein is a resistance detection circuit 148, a resistance threshold register 150, a clock circuit 152, a comparator 154, a latch circuit 156, a reset circuit 158, a counter 160 and an indicator 162. The resistance detection circuit 148 monitors the resistance of the continuity circuit 146 and provides an output value 164 to the comparator 154. Upon encountering a mechanical shock of sufficient force, separation between the conductive film 136 and the conductive surface 132 (of FIG. 1) occurs. As a result of the separation between the conductive film 136 and the conductive surface 132, the output value 164 of the resistance detection circuit 148 changes.

The comparator 154 compares the output value 164 with a threshold resistance value stored in the resistance threshold register 150. If the output value 164 differs in a predetermined direction from the threshold resistance value, the comparator 154 outputs a latching signal 166 to the latch circuit 156. The latching signal 166 remains active for the duration of the separation between the conductive film 136 and the conductive surface 132.

The latch circuit 156 latches in a constant frequency signal 167 of the clock circuit 152 for the duration of separation between the conductive film 136 and the conductive surface 132, and provides a pulsed clock signal 168 to the counter 160. The counter 160 counts a number of pulses of the pulsed clock signal 168 that occur over the duration of the separation between the conductive film 136 and the conductive surface 132, and provides to the indicator 162 a count output signal 169 indicative of the duration of the separation between the conductive film 136 and the conductive surface 132.

At the conclusion of the head-slap event, the conductive film 136 returns to conductively communicate with the conductive surface 132, the comparator 154 ceases to provide the latching signal 166 to the latch circuit 156, the latch circuit unlatches the clock circuit 152 from the counter 160, and the reset circuit 158 resets the counter 160.

In alternate preferred embodiments, the count output signal may be provided to a memory register or a processor or other reporting devices and made available for evaluation.

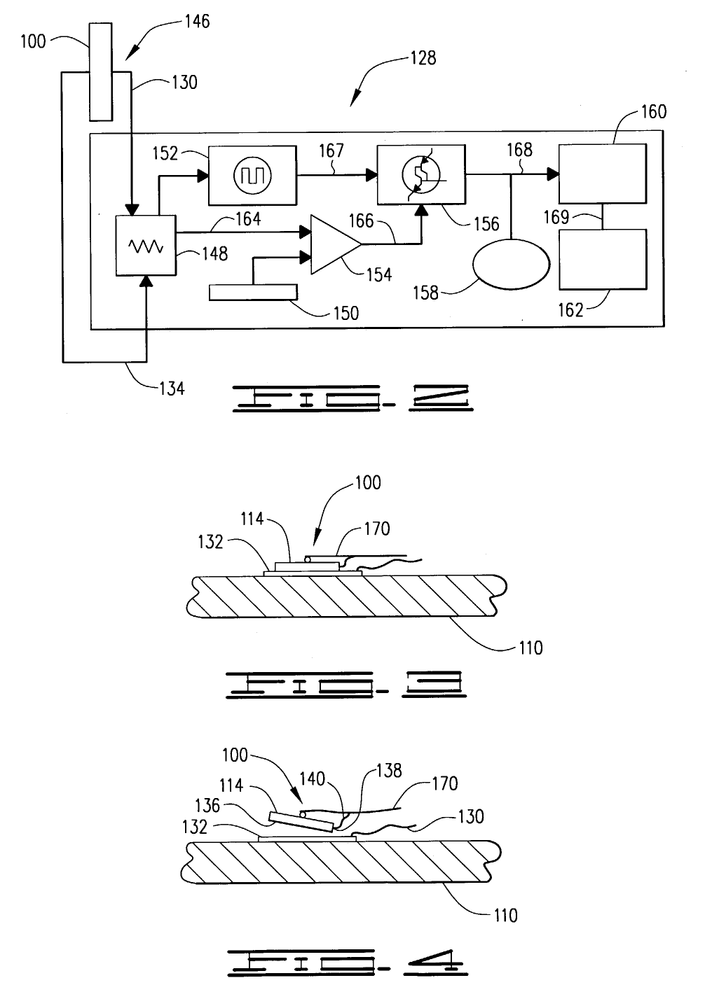

FIGS. 3, 4, 5 and 6 may best be viewed collectively. FIG. 3 shows the head 114 in a nominal relationship, relative to the conductive film 136, absent a presence of a mechanical shock sufficient to cause separation between the conductive film 136 and the head 114. It is noted that the conductive surface 132 provides an insulated pad between the disc 110 and the head 114.

For embodiments of the disc drive 100 (of FIG. 1) with a plurality of paired discs 110 and heads 114, each head/disc pair is prepared in accordance with the teachings of the present invention to individually provide continuity and discontinuity responses to mechanical shocks imparted on the disc drive 100. Electrical insulation of the conductive film 136 from the disc 110 promotes isolation of the output values 164 (of FIG. 2) for each pair of head 114 and disc 110 interfaces.

FIG. 4 shows the conductive film 136 communicating with the head 114 and the solder joint 138. The solder joint 138 provides electrical contact between the head lead 140 and the preamp 142 during data transfer operations. The head lead 140 also electrically communicates with the second lead 134 (of FIG. 1) to form a first portion of the continuity circuit 146 of the head-slap detection circuit 128 (of FIG. 2).

The first lead 130 electrically communicates with the conductive surface 132 to form a second portion of the continuity circuit 146. With separation between the conductive film 136 and the conductive surface 132, discontinuity within the continuity circuit 146 occurs, causing a change in resistance of the continuity circuit 146. FIG. 4 shows such a separation. Additionally, shown by FIG. 4 is a first stage of a head-slap event, i.e., separation of the head 114 from the disc 110.

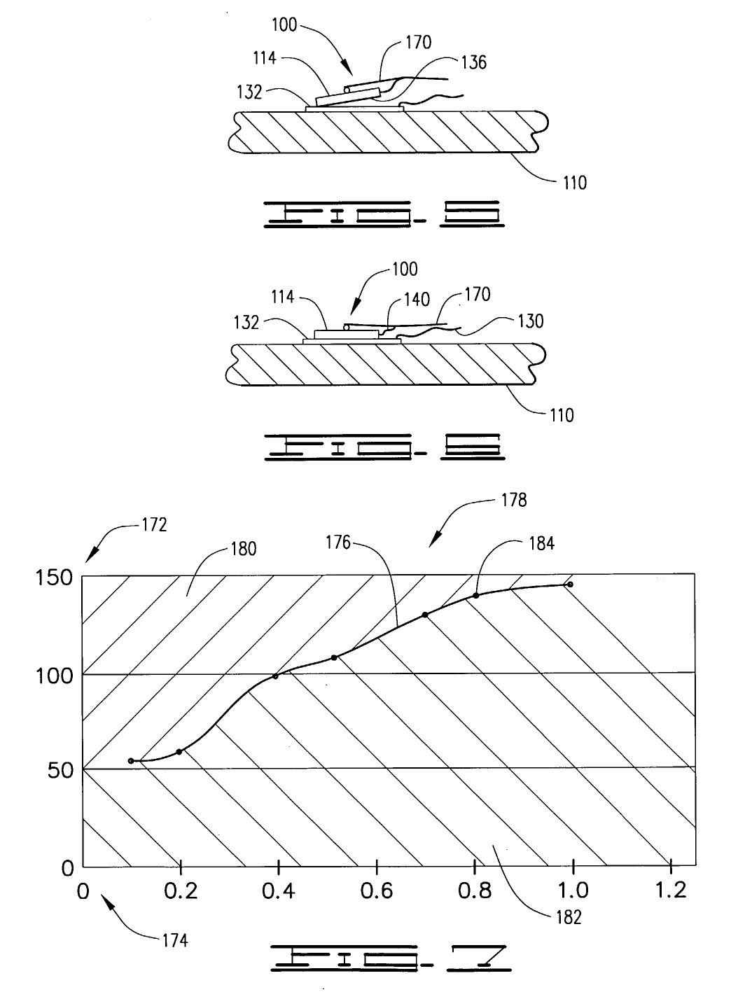

FIG. 5 shows a second stage of the head-slap event. The head 114 whiplashes back toward the disc 110 propelled by a head suspension 170 responding to the mechanical shock imparted on the disc drive 100.

FIG. 6 shows a final stage of the head-slap event. Edges of the head 114 interact with the disc 110 which can generate particles and damage the disc 110 and/or the head 114.

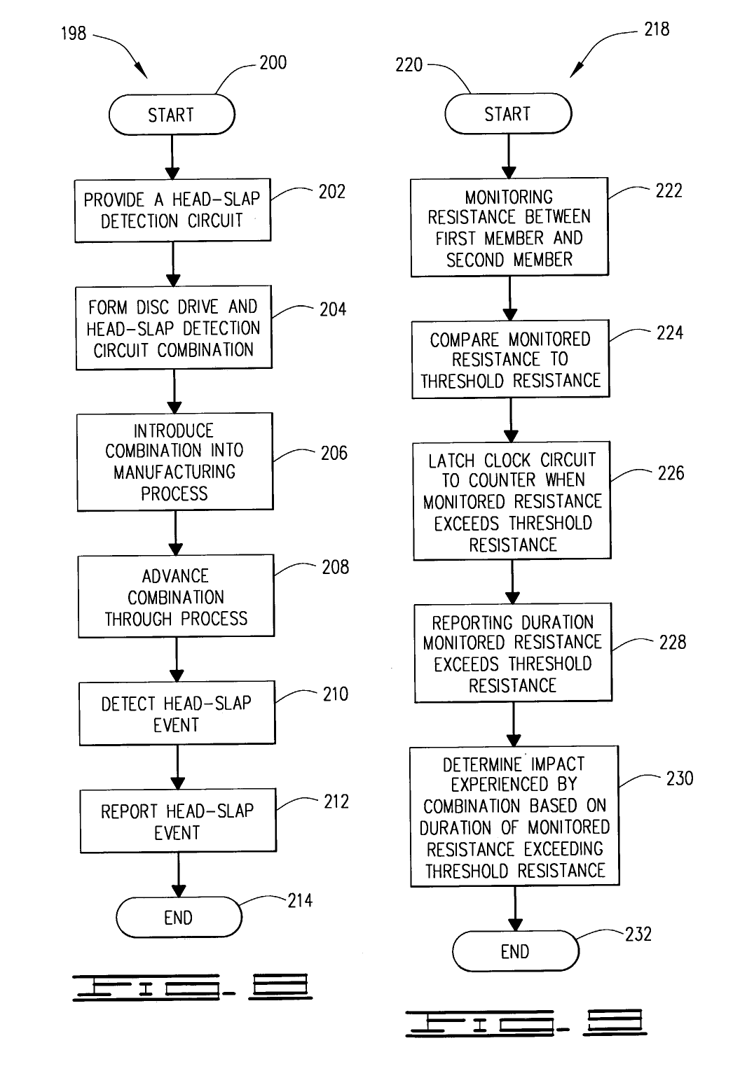

Turning to FIG. 7, shown therein is a vertical axis 172 expressed in units of gravitational force (G's), a horizontal axis 174 expressed in milliseconds and a head-slap boundary curve 176 of a head-slap boundary graph 178. An unsafe region 180 lies above the head-slap boundary curve 176 while a safe region 182 lies below the head-slap boundary curve 176. For example, a mechanical shock with a force of 100 G's imparted on the disc drive 100 will result in a head-slap event. The duration of the head-slap event is substantially 0.4 milliseconds. A separation between the conductive film 136 (of FIG. 4) and the conductive surface 132 (of FIG. 4) for a duration of 0.4 milliseconds places the head 114 (of FIG. 5) in the unsafe region 180 of the head-slap boundary graph 178.

Using a measurement of the duration of separation between the conductive film 136 and the conductive surface 132 and the head-slap boundary curve 176, the force of a mechanical shock causing the separation can be determined from the head-slap boundary graph 178. Knowledge of the amount of force imparted on the disc drive 100 provides insight into potential sources of the mechanical shock. Insight into potential sources of mechanical shock allows for elimination of the source through re-engineering of the manufacturing process.

In a preferred embodiment, a head-slap boundary curve (such as 176) is empirically determined for a disc drive (such as 100). Because of variations in configuration between models of disc drives, a head-slap boundary curve for one model of disc drive is generally not applicable to an alternate disc drive model. As such, a head-slap boundary curve for any disc drive model of interest is empirically determined for that disc drive model.

In establishing the head-slap boundary curve, a head-slap detection circuit (such as 128) is adapted to the disc drive of interest. In preparing the disc drive for use in establishing a head-slap boundary curve, a conductive surface (such as 132) is attached to a disc (such as 110) of the disc drive, and a conductive film (such as 136) is applied to a head (such as 114) of the disc drive. With the conductive surface and conductive film in place, a first lead (such as 130) is secured between the conductive surface and the head-slap detection circuit, while a second lead (such as 134) affixed between the conductive film and the head-slap detection circuit provides a conductive path between the conductive film and the head-slap detection circuit.

In a preferred embodiment, the conductive film is provided by sputtering gold onto the surface of the head and onto a solder joint (such as 138) affixed adjacent the surface of the head and in electrical communication with an active element of the head. The solder joint 138 secures a first end of a head lead (such as 140) to the active element of the head. A first end of the second lead attaches to a distal end of the head lead, while the second end of the second lead attaches to the head-slap detection circuit.

With the head-slap detection circuit adapted to the disc drive, the disc drive can be subjected to shock testing using a conventional shock machine such as a shock machine provided by MIRAD Corporation of Woburn, Mass., USA. A series of predetermined forces are individually imparted on the disc drive by the shock machine. If separation between the conductive surface and the conductive film results from any of the applied force, a head-slap event will have occurred.

In response to the occurrence of the head-slap event, the head-slap detection circuit captures the event and reports the duration of separation. The duration of the separation is plotted against the level of force applied to the disc drive to form a shock point (such as 184) of the head-slap boundary curve. Shock testing continues with application to the disc drive of the various predetermined shock forces until a sufficient number of shock points have been established to generate the head-slap boundary curve.

FIG. 8 shows a flowchart 198 of a preferred embodiment of a method of determining a head-slap event for a disc drive (such as 100) in accordance with preferred embodiments of the present invention starting at start process step 200 and continuing at process step 202, where a head-slap detection circuit (such as 128) is provided. At process step 204, the head-slap detection circuit is adapted to the disc drive to form a disc drive and head-slap detection combination (such as 129). At process step 206, the combination is introduced into an elected portion of a disc drive manufacturing process. The combination progresses through the elected portion of the disc drive manufacturing process at process step 208.

While progressing through the elected portion of the disc drive manufacturing process, the combination experiences substantially the same mechanical shock experienced by a disc drive of the same model progressing through the elected portion of the disc drive manufacturing process (that is, the same model of the disc drive used in forming the disc drive and head-slap detection circuit combination). At process step 210, a mechanical shock event experienced by the combination of sufficient magnitude is captured by the head-slap detection circuit as a head-slap event. At process step 212, the head-slap event is reported by the head-slap detection circuit, and the method of determining a head-slap event shown by flowchart 198 concludes with process step 214.

FIG. 9 shows a flowchart 218 for a preferred embodiment of a process of determining an impact force of a head-slap event for a disc drive (such as 100) in accordance with preferred embodiments of the present invention starting at start process step 220 and continuing at process step 222, where a resistance detection circuit (such as 148) monitors a resistance between a first member (such as conductive surface 132) and a second member (such as conductive film 136) for detection of a head-slap event. At process step 224, the monitored resistance is compared by a comparator (such as 154) to a predetermined threshold resistance value stored in a resistance threshold register (such as 150).

Upon an occurrence of the monitored resistance exceeding the threshold resistance value, the comparator provides a latching signal (such as 166) to a latch circuit (such as 156). The latch circuit latches a constant frequency signal (such as 167) provided by a clock circuit (such as 152) to a counter (such as 160). The counter measures a duration of the change in resistance between the first member and the second member at process step 226.

At process step 228, the duration of the change in resistance between the first member and the second member is reported via an indicator (such as 162) for use in determining the level of impact force experienced by the disc drive and head-slap detection circuit combination. At process step 230, the duration of the change in resistance between the first member and the second member is translated to an impact force value through use of an empirically determined head-slap boundary graph (such as 178). At process step 232, the process of determining impact force of a head-slap event for the disc drive concludes.

In accordance with preferred embodiments, a combination (such as 129) is formed from an adaptation of a head-slap detection circuit (such as 128) to a disc drive (such as 100) that includes a data transducing head (such as 114) adjacent a recording surface (such as 111). In forming the combination, a conductive surface (such as 132) is attached to the recording surface, and a conductive film (such as 136) is affixed to the data transducing head.

A first lead (such as 130) provides a conductive path between the conductive surface and the head-slap detection circuit to form a first portion of a continuity circuit (such as 146). A second lead (such as 134) provides a conductive path between the conductive film and the head-slap detection circuit to complete the continuity circuit.

The head-slap detection circuit includes: a resistance detection circuit (such as 148) monitoring a resistance between the conductive surface and the conductive film; a resistance threshold register (such as 150) storing a threshold resistance value for comparison to the monitored resistance; and a comparator (such as 154) communicating with the resistance detection circuit and the resistance threshold register, comparing the monitored resistance with the threshold resistance value.

The head-slap detection circuit also includes a clock circuit (such as 152) in electronic communication with the resistance detection circuit providing a constant frequency signal (such as 167), while the resistance detection circuit monitors the resistance between the conductive surface and the conductive film, and a latch circuit (such as 157) responsive to the comparator providing a pulsed clock signal (such as 168) while latching the constant frequency signal to a counter (such as 160) in response to a change in resistance of the monitored resistance.

The counter counts a pulse of the pulsed clock signal in response to the change in resistance of the monitored resistance, and outputs a count output signal (such as 169) to an indicator (such as 162) memorializing a head-slap event in response to the counter counting the pulse. A reset circuit (such as 158) in communication With the latch circuit responds to an absence of the pulsed clock signal by resetting the counter at the conclusion of a head-slap detection test sequence.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts, within the principles of the present invention to the full extent indicated by the broad general meaning of the terms in which the appended claims are expressed without departing from the spirit and scope of the present invention.

What is claimed is:

1. A combination comprising:
a data storage device comprising a data transducing head adjacent a recording surface; and
a head-slap detection system comprising an electrical continuity circuit that is selectively operable in response to a mechanical shock to vary the electrical resistance in the electrical continuity circuit in relation to a magnitude of the mechanical shock.

2. The combination of claim 1, further comprising:
a conductive surface attached to the recording surface;
a first lead communicating with the conductive surface and the head-slap detection circuit forming a first portion of a continuity circuit;
a conductive film affixed to the data transducing head; and
a second lead communicating with the conductive film and the head-slap detection circuit completing the continuity circuit.

3. The combination of claim 2, in which the head-slap detection circuit comprises:
a resistance detection circuit monitoring a resistance between the conductive surface and the conductive film;
a resistance threshold register storing a threshold resistance value for evaluation with the monitored resistance;
a comparator communicating with the resistance detection circuit and the resistance threshold register comparing the monitored resistance with the threshold resistance value;
a clock circuit responsive to the resistance detection circuit providing a constant frequency signal while the resistance detection circuit monitors the resistance between the conductive surface and the conductive film;
a latch circuit responsive to the comparator providing a pulsed clock signal while latching the constant frequency signal in response to a change in resistance of the monitored resistance;
a counter communicating with the latch circuit counting a pulse of the pulsed clock signal in response to the change in resistance of the monitored resistance;
an indicator responsive to the counter registering a head-slap event in response to the counter counting a pulse; and
a reset circuit communicating with the latch circuit responsive to an absence of the pulsed clock signal resetting the counter.

4. The combination of claim 3, in which the change in resistance of the monitored resistance results from an increase in resistance of the monitored resistance to a resistance level greater than the threshold resistance value, and wherein the latch circuit latches in the clock circuit and provides the pulse of the pulsed clock signal in response to the increase in the monitored resistance to a resistance level greater than the threshold resistance value.

5. The combination of claim 3, in which the change in resistance of the monitored resistance results from a decrease in resistance of the monitored resistance to a resistance level less than the threshold resistance value, and wherein the latch circuit unlatches the clock circuit and abstains from providing the pulsed clock signal in response to the decrease in the monitored resistance to a resistance level less than the threshold resistance value.

6. The combination of claim 4, in which the counter provides a count output signal indicative of a duration that the resistance of the monitored resistance remains greater than the threshold resistance value.

7. The combination of claim 3, in which the conductive film is substantially in continuous contact with the conductive surface, and wherein the change in resistance of the monitored resistance results from a separation of the conductive film from the conductive surface.

8. The combination of claim 7, in which the duration that the resistance of the monitored resistance remains greater than the threshold resistance value is substantially a duration of the separation of the conductive film from the conductive surface.

9. A method comprising the steps of:
providing a head-slap detection circuit;
adapting the head-slap detection circuit to a data storage device comprising a data transducing head adjacent a recording surface to form a data storage device and head-slap detection combination;
introducing the combination into an elected portion of a data storage device manufacturing process;
passing the combination through the elected portion of the data storage device manufacturing process to monitor for an occurrence of a head-slap event;
detecting a mechanical shock event experienced by the combination as the head-slap event; and
reporting the occurrence of the head-slap event.

10. The method of claim 9, in which detecting the head-slap event comprises the steps of:
monitoring a resistance between a conductive surface attached to the recording surface and a conductive film affixed to the data transducing head;
comparing the resistance between the conductive surface attached to the recording surface and the conductive film affixed to the data transducing head to a threshold resistance;
latching a clock circuit to a counter upon an occurrence of the monitored resistance exceeding the threshold resistance;
reporting a duration that the monitored resistance exceeds the threshold resistance; and
determining a level of impact experienced by the disc drive and head-slap detection combination based on the duration that the monitored resistance exceeds the threshold resistance.

11. The method of claim 9, in which the head-slap detection circuit comprises:
a resistance detection circuit monitoring a resistance between the conductive surface and the conductive film;
a resistance threshold register storing a threshold resistance value for evaluation with the monitored resistance;
a comparator communicating with the resistance detection circuit and the resistance threshold register comparing the monitored resistance with the threshold resistance value;
a clock circuit responsive to the resistance detection circuit providing a constant frequency signal while the resistance detection circuit monitors the resistance between the conductive surface and the conductive film;
a latch circuit responsive to the comparator latching the constant frequency signal in response to a change in resistance of the monitored resistance and providing a pulsed clock signal;
a counter communicating with the latch circuit counting a pulse of the pulsed clock signal in response to the change in resistance of the monitored resistance;
an indicator responsive to the counter registering a head-slap event in response to the counter counting a pulse; and
a reset circuit communication with the latch circuit responsive to an absence of the pulsed clock signal resetting the counter.

12. A combination comprising:
a data storage device comprising a data transducing head adjacent a recording surface; and
means for detecting a head-slap event by steps for detecting the head-slap event.

13. The combination of claim 12, in which the means for detecting a head-slap event comprises:
a resistance detection circuit monitoring a resistance between the conductive surface and the conductive film;
a resistance threshold register storing a threshold resistance value for evaluation with the monitored resistance;
a comparator communicating with the resistance detection circuit and the resistance threshold register comparing the monitored resistance with the threshold resistance value;
a clock circuit responsive to the resistance detection circuit providing a constant frequency signal while the resistance detection circuit monitors the resistance between the conductive surface and the conductive film;
a latch circuit responsive to the comparator latching the constant frequency signal in response to a change in resistance of the monitored resistance and providing a pulsed clock signal;
a counter communicating with the latch circuit counting a pulse of the pulsed clock signal in response to the change in resistance of the monitored resistance;
an indicator responsive to the counter registering a head-slap event in response to the counter counting a pulse; and
a reset circuit communication with the latch circuit responsive to an absence of the pulsed clock signal resetting the counter.

14. The combination of claim 12, in which the steps for detecting the head-slap event comprises steps of:
monitoring a resistance between a conductive surface attached to the recording surface and a conductive film affixed to the data transducing head;
comparing the resistance between the conductive surface attached to the recording surface and the conductive film affixed to the data transducing head to a threshold resistance;
latching a clock circuit to a counter upon an occurrence of the monitored resistance exceeding the threshold resistance;
reporting a duration that the monitored resistance exceeds the threshold resistance; and
determining a level of impact experienced by the disc drive and head-slap detection combination based on the duration that the monitored resistance exceeds the threshold resistance.

15. The combination of claim 13, in which the change in resistance of the monitored resistance results from an increase in resistance of the monitored resistance to a resistance level greater than the threshold resistance value, and wherein the latch circuit latches in the clock circuit and provides the pulse of the pulsed clock signal in response to the increase in the monitored resistance to a resistance level greater than the threshold resistance value.

16. The combination of claim 13, in which the change in resistance of the monitored resistance results from a decrease in resistance of the monitored resistance to a resistance level less than the threshold resistance value, and wherein the latch circuit unlatches the clock circuit and abstains from providing the pulsed clock signal in response to the decrease in the monitored resistance to a resistance level less than the threshold resistance value.

17. The combination of claim 15, in which the counter provides a count output signal indicative of a duration that the resistance of the monitored resistance remains greater than the threshold resistance value.

18. The combination of claim 13, in which the conductive film is substantially in continuous contact with the conductive surface, and wherein the change in resistance of the monitored resistance results from a separation of the conductive film from the conductive surface.

19. The combination of claim 18, in which the duration that the resistance of the monitored resistance remains greater than the threshold resistance value is substantially a duration of the separation of the conductive film from the conductive surface.

20. An apparatus comprising:
a resistance detection circuit monitoring a resistance between a first member and a second member;
a resistance threshold register storing a threshold resistance value for evaluation with the monitored resistance;
a comparator communicating with the resistance detection circuit and the resistance threshold register comparing the monitored resistance with the threshold resistance value;
a clock circuit responsive to the resistance detection circuit providing a constant frequency signal while the resistance detection circuit monitors the resistance between the first member and the second member;
a latch circuit responsive to the comparator providing a pulsed clock signal while latching the constant frequency signal in response to a change in resistance of the monitored resistance;
a counter communicating with the latch circuit counting a pulse of the pulsed clock signal in response to the change in resistance of the monitored resistance;
an indicator responsive to the counter registering a head-slap event in response to the counter counting a pulse; and
a reset circuit communication with the latch circuit responsive to an absence of the pulsed clock signal resetting the counter.
